(19) United States
(12) Patent Application Publication
(10) Pub. No.: US 2016/0057826 A1
(43) Pub. Date: Feb. 25, 2016

(54) AN ELECTRONIC AC LINE DIMMING CIRCUIT WITH NEAR UNITY POWER FACTOR

(71) Applicant: 3M INNOVATIVE PROPERTIES COMPANY, Saint Paul, MN (US)

(72) Inventors: Martin J. Vos, St. Paul, MN (US); Gregory G. Jager, Oakdale, MN (US)

(73) Assignee: 3M Innovative Properties Company, St. Paul, MN (US)

(21) Appl. No.: 14/781,358

(22) PCT Filed: Mar. 28, 2014
(86) PCT No.: PCT/US2014/032187

§ 371 Date: Sep. 30, 2015

Related U.S. Application Data
(60) Provisional application No. 61/808,007, filed on Apr. 3, 2013.

(51) Int. Cl. H05B 33/08

(52) U.S. Cl. CPC H05B 33/0818; H05B 33/0845

(57) ABSTRACT

The present disclosure features a dimming circuit connected to an AC line, comprising a dimming adjuster circuit, a dimming control circuit, and a transformer circuit. The dimming adjuster circuit comprises a dimming level adjuster and is configured to generate a tracking signal indicative of a setting of the dimming level adjuster. The dimming control circuit is coupled to the dimming adjuster circuit. The dimming control circuit is configured to receive the tracking signal and generate a dimming signal. The transformer circuit is coupled to the dimming control circuit. The transformer circuit is configured to receive the dimming signal and provide power to a lighting assembly in response to the dimming signal.

### TECHNICAL FIELD

The present disclosure relates to a dimmer control used on an Alternating Current (AC) line.

### SUMMARY

At least some aspects of the present disclosure features a dimming circuit connected to an AC line, comprising a dimming adjuster circuit, a dimming control circuit, and a transformer circuit. The dimming adjuster circuit is connected to the AC line. The dimming adjuster circuit comprises a dimming level adjuster and is configured to generate a tracking signal indicative of a setting of the dimming level adjuster. The tracking signal generally tracks the line voltage of the AC line. The dimming control circuit is coupled to the dimming adjuster circuit. The dimming control circuit is configured to receive the tracking signal and generate a dimming signal. The transformer circuit is coupled to the dimming control circuit. The transformer circuit is configured to receive the dimming signal and provide power to a lighting assembly in response to the dimming signal. The transformer circuit comprises a flyback transformer.

### BRIEF DESCRIPTION OF THE DRAWINGS

The accompanying drawings are incorporated in and constitute a part of this specification and, together with the description, explain the advantages and principles of the invention. In the drawings,

FIG. 1 illustrates a block diagram of an exemplary embodiment of a dimming circuit;

FIGS. 2A and 2B are illustrative circuit diagrams for one embodiment of a dimming circuit coupled to a lighting assembly; and

FIG. 3 is a graph illustrating power factor performance.

### DETAILED DESCRIPTION

At least some aspects of the present disclosure directs to AC line dimming for luminaires. Existing AC line phase cut dimmers, for example, TRIAC based dimmers, have poor power factor performance for low power settings. This is demonstrated by Equation (1) relating power factor PF with normalized time averaged transmitted power <p>. With T the time period of one AC cycle and with 0≦τ₁<τ₂≦T, the relationship between PF and <p> is then given by:

$$\begin{matrix}PF = \frac{〈 P 〉}{{V}_{rms} {I}_{rms}} \\ = \frac{\frac{1}{T} {\int }_{0}^{T} {V}_{p} sin ω t {I}_{p} sin ω t d t}{\frac{{V}_{p}}{\sqrt{2}} \sqrt{\frac{1}{T} {\int }_{0}^{T} {I}_{p} sin ω {tI}_{p} sin ω t d t}} \\ = \frac{\frac{{V}_{p} {I}_{p}}{T} {\int }_{{τ}_{1}}^{{τ}_{2}} {sin}^{2} ω t d t}{\sqrt{\frac{{V}_{p} {I}_{p}}{2}} \sqrt{\frac{{V}_{p} {I}_{p}}{T} {\int }_{{τ}_{1}}^{{τ}_{2}} {sin}^{2} ω t d t}} \\ = \frac{\sqrt{\frac{{V}_{p} {I}_{p}}{T} {\int }_{{τ}_{1}}^{{τ}_{2}} {sin}^{2} ω t d t}}{\sqrt{\frac{{V}_{p} {I}_{p}}{2}}} \\ = \frac{\sqrt{〈 P 〉}}{\sqrt{\frac{{V}_{p} {I}_{p}}{2}}} \\ = \sqrt{〈 p 〉} ,\end{matrix} \qquad ( 1 )$$

where rms denotes root-mean-square, t is a time variable in seconds, ω is an angular frequency 2π/T, Vₚ is the peak voltage, Iₚ is the peak current, V is line voltage and equal to Vₚ sin ωt, I is line current, P is power=VI, and <P> is time averaged power. At least some aspects of the present disclosure are directed to a dimming method that does not rely on phase cutting.

At least some aspects of the present disclosure directs to dimming circuits implementing amplitude dimming, which can have good power factor performance. In some embodiments, a dimming circuit can include a dimming adjuster circuit allowing users to adjust dimming levels, a dimming control circuit and a transformer circuit. In some cases, the dimming circuit can track the line voltage of the AC line and provide line isolation such that harmonic dimming can be achieved. In some implementations, the dimming circuit can be used as part of a dimmer for a Light Emitting Diode (LED) lighting assembly.

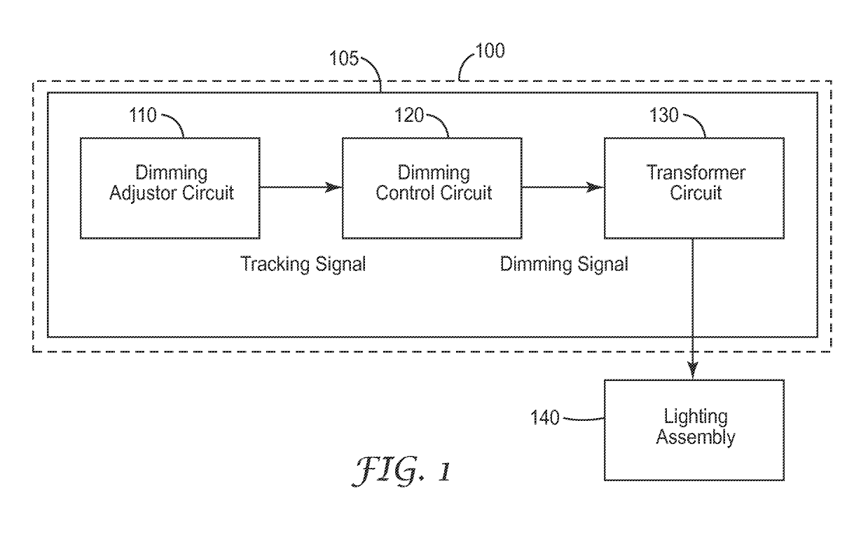

FIG. 1 illustrates a block diagram of an exemplary embodiment of a dimming circuit 100 coupled to a lighting assembly 140. In some embodiments, the dimming circuit 100 can include a dimming adjuster circuit 110, a dimming control circuit 120, and a transformer circuit 130. The dimming adjuster circuit 110 can be connected to the AC line and includes a dimming level adjuster. The dimming adjuster circuit 110 is configured to generate a tracking signal indicative of a setting of the dimming level adjuster. In addition, the tracking signal generally tracks a line voltage of the AC line. The dimming control circuit 120 is coupled to the dimming adjuster circuit and configured to receive the tracking signal. The dimming control circuit 120 is also configured to generate a dimming signal. The transformer circuit 130 is coupled to the dimming control circuit and configured to receive the dimming signal. The transformer circuit 130 is also configured to provide power to a lighting assembly in response to the dimming signal. In some embodiments, the transformer circuit includes a flyback transformer.

In some cases, the dimming circuit 100 can optionally have a housing 105 that is different from a housing of the lighting assembly 140. The dimming adjuster circuit 110, the dimming control circuit 120, and/or the transformer circuit 130 can be disposed in the housing 105. In some implementations, at least part of the dimming adjuster circuit 110 can be accessible through the housing 105, for example, a knob, a switch, or a button on the outside surface of the housing. In some cases, the dimming circuit 100 has a power factor greater than 0.8. In yet some cases, the dimming circuit 100 has a power factor greater than 0.9.

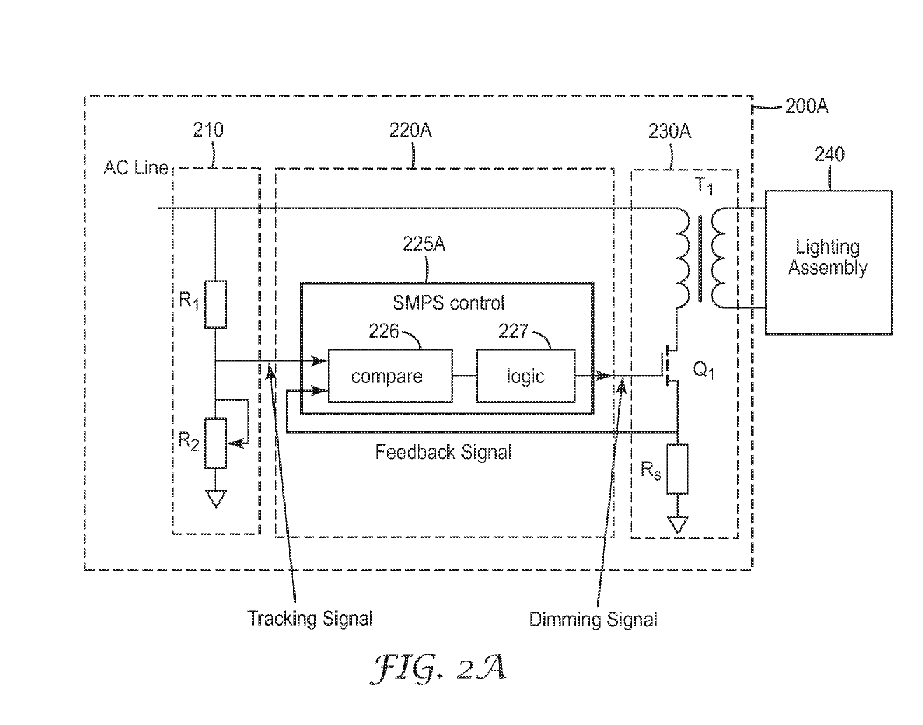

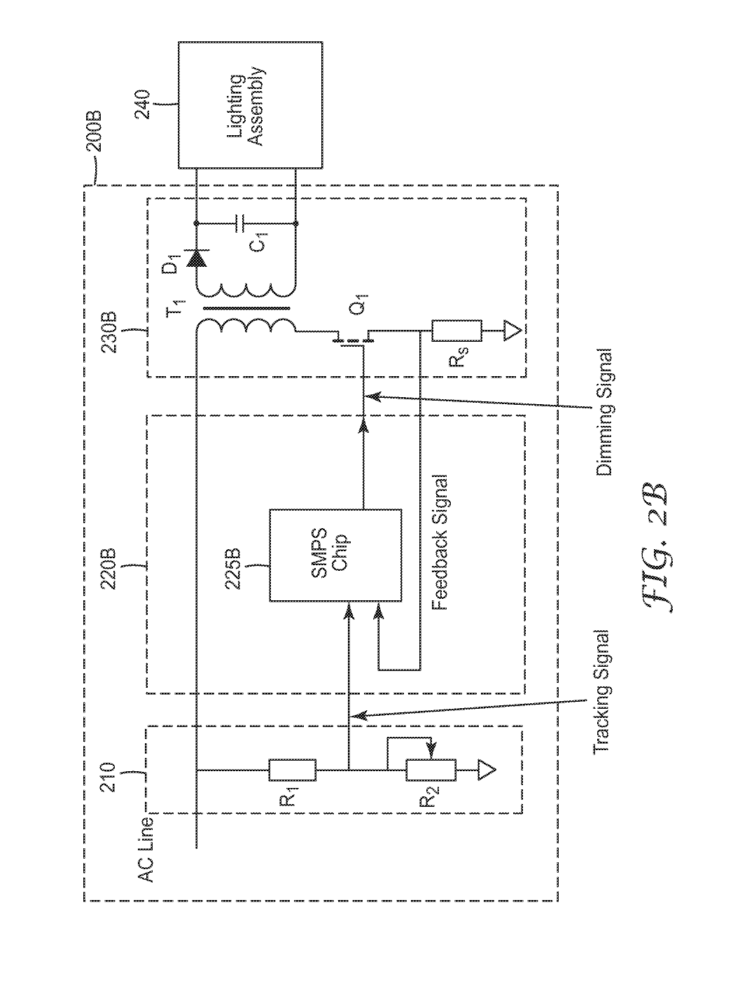

FIG. 2A is an illustrative circuit diagram for one embodiment of a dimming circuit 200A coupled to a lighting assembly 240. As illustrated in this embodiment, the dimming circuit 200A includes a dimming adjuster circuit 210, a dimming control circuit 220A, and a transformer circuit 230A. The dimming adjuster circuit 210 can include a resistor R₁ and a potentiometer R₂. The dimming adjuster circuit 210 is coupled to the AC line and configured to generate a tracking signal. In this embodiment, the tracking signal is a fraction of the line voltage of the AC line, while the fraction is controllable by adjusting the value of R₂. In this embodiment, R₂ is functioned as a dimming level adjuster. In some cases, the tracking signal is proportional to the resistance value of R₂. The dimming control circuit 220A can include a switch-mode power supply (SMPS) control 225A, which includes a compare component 226 and a logic component 227. The compare component 226 receives the tracking signal and a feedback signal from the transformer circuit 230A and compares these two signals. The logic component 227 produces a dimming signal based upon the comparison of the tracking signal and the feedback signal. In the embodiment illustrated in FIG. 2A, the transformer circuit 230A can include a transformer T₁, a transistor Q₁, and a resistor Rₛ. In some cases, the transformer T₁ is a flyback transformer and the transistor Q₁ is coupled to the primary inductance of the flyback transformer T₁. The high frequency switching produced by the logic component 227 allows a much smaller transformer T₁ than, for example, low frequency 60 Hz variac dimming. The lighting assembly 240 in FIG. 2A can contain LEDs and possibly other electronic components.

In some implementations, the compare component 226 is a comparator with analog inputs and digital output. As an example, the output of the compare component 226 goes low when the feedback signal amplitude exceeds the tracking signal amplitude. The output of the logic component 227 can go low, if the logic component 227 implements such logic, resulting in the input to the transformer circuit 230A current becoming zero. But then also the feedback signal current amplitude becomes zero. If nothing else would happen in the feedback loop, the output of the compare component 226 would immediately become high to try to restore current flow through the transformer circuit. But this current restoration is prevented by the logic component 227 during an imposed off time (e.g., about 8 μs). Only after this off time the logic output is allowed to go high, after which the process repeats.

FIG. 2B is another illustrative circuit diagram for a dimming circuit 200B coupled to a lighting assembly 240. As illustrated in this embodiment, the dimming circuit 200B includes a dimming adjuster circuit 210, a dimming control circuit 220B, and a transformer circuit 230B. The dimming adjuster circuit 210 can include a resistor R₁ and a potentiometer R₂. The dimming adjuster circuit 210 is coupled to the AC line and configured to generate a tracking signal. In this embodiment, the tracking signal is a fraction of the line voltage of the AC line, while the fraction is controllable by adjusting the value of R₂. The dimming control circuit 220B can include a SMPS chip 225B, which is an integrated circuit (IC) chip. The SMPS chip 225B receives the tracking signal and a feedback signal from the transformer circuit 230B and compares these two signals. The SMPS chip 225B produces a dimming signal based upon the comparison of the tracking signal and the feedback signal. In the embodiment illustrated in FIG. 2B, the transformer circuit 230B can include a transformer T₁, a transistor Q₁, a resistor Rₛ, a capacitor C₁, and a switch D₁. For the dimming circuit 200B in FIG. 2B, it can be shown that with D the on-off duty cycle provided by the SMPS chip 225B and with Vₚ the peak AC line voltage, the mean power <P> delivered to the transformer T₁ is equal to:

$$〈 P 〉 = \frac{{V}_{p}^{2} D}{4 {R}_{s}} \cdot \frac{{R}_{2}}{{R}_{1} + {R}_{2}} \qquad ( 2 )$$

Therefore, R₂ can be used for dimming and the choice of a fixed Rₛ can set the dimmer power rating. In some cases, this dimming approach is suitable for LED lighting assemblies because power levels of 10 W or 100 W, for example, can be obtained with practical values of R₁, R₂ and Rₛ.

In some cases, the transformer T₁ is a flyback transformer and the transistor Q₁ is coupled to the primary inductance of the flyback transformer T₁. The switch D₁ can be coupled to the secondary inductance of the flyback transformer T₁. A capacitor C₁ can be coupled to D₁ to filter high frequency current transients. In some cases, the transformer circuit 230B includes the switch D₁ to maintain flyback operation. In some implementations, as illustrated in FIG. 2B, the switch D₁ is a rectifying diode. In some other implementations, the switch D₁ is a synchronized bidirectional switch when full wave AC power transfer is desired. The bidirectional switch can be controlled by the logic component 227 with additional isolation circuitry.

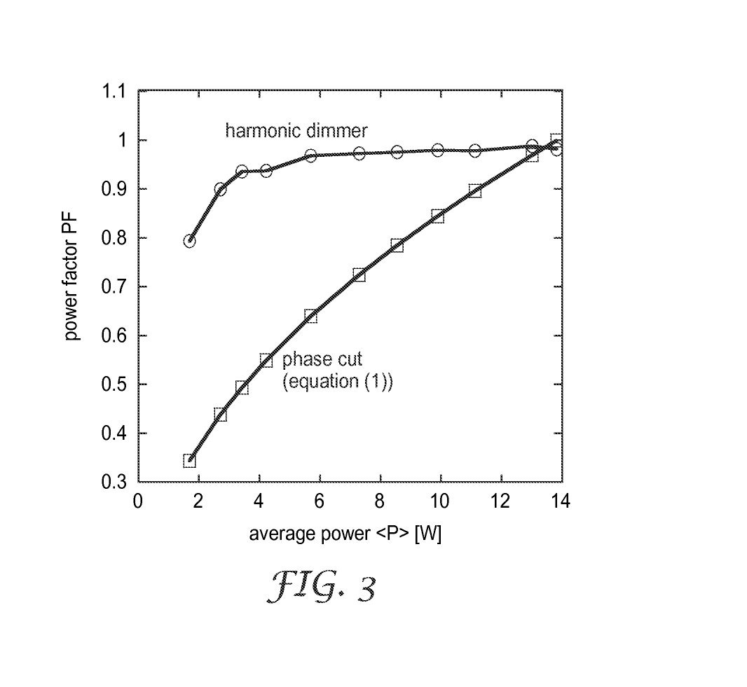

At least some embodiments of the present disclosure can be dimming circuits for LED lighting assemblies. For example, the SMPS chip 225B in the circuit diagram illustrated in FIG. 2B can be a LED driver chip such as LM3444 (available from Texas Instruments, Dallas, Tex.), HV9910 (available from Supertex, Inc Sunnyvale, Calif.), L6561 (available from STMicroelectronics, Geneva, Switzerland) or similar commercially available SMPS chips. FIG. 3 is a graph illustrating power factor performance with circuitry similar to the circuit design in FIG. 2B in comparison with the power factor performance of a phase cutting dimming circuit computed using equation (1). FIG. 3 shows that the power factor PF for a dimming circuit similar to the circuit design in FIG. 2B is generally greater than 0.8, and a large portion greater than 0.9.

### Exemplary Embodiments

### Embodiment One

A dimming circuit connected to an AC line, comprising:

a dimming adjuster circuit connected to the AC line, the dimming adjuster circuit comprising a dimming level adjuster and configured to generate a tracking signal indicative of a setting of the dimming level adjuster, the tracking signal generally tracking line voltage of the AC line,

a dimming control circuit coupled to the dimming adjuster circuit, the dimming control circuit configured to receive the tracking signal and generate a dimming signal, and

a transformer circuit coupled to the dimming control circuit, the transformer circuit configured to receive the dimming signal and provide power to a lighting assembly in response to the dimming signal, the transformer circuit comprising a flyback transformer.

### Embodiment Two

The dimming circuit of Embodiment One, further comprising:

a housing different from a housing of the lighting assembly, the housing containing the dimming adjuster circuit, the dimming control circuit, and the transformer circuit.

### Embodiment Three

The dimming circuit of Embodiment One or Embodiment Two, wherein the dimming circuit has a power factor greater than 0.8.

### Embodiment Four

The dimming circuit of any one of Embodiment One through Embodiment Three, wherein the dimming control circuit comprises a switch-mode power supply (SMPS) control.

### Embodiment Five

The dimming circuit of any one of Embodiment One through Embodiment Four, wherein the transformer circuit comprises a switch coupled to the secondary inductance of the flyback transformer.

### Embodiment Six

The dimming circuit of Embodiment Five, wherein the switch comprises a diode.

### Embodiment Seven

The dimming circuit of Embodiment Five, wherein the switch comprises a synchronized switch.

### Embodiment Eight

The dimming circuit of any one of Embodiment One through Embodiment Seven, wherein the transformer circuit comprises a transistor coupled to the primary inductance of the flyback transformer.

### Embodiment Nine

The dimming circuit of any one of Embodiment One through Embodiment Eight, wherein the dimming level adjuster comprises a potentiometer.

The present invention should not be considered limited to the particular examples and embodiments described above, as such embodiments are described in detail to facilitate explanation of various aspects of the invention. Rather the present invention should be understood to cover all aspects of the invention, including various modifications, equivalent processes, and alternative devices falling within the spirit and scope of the invention as defined by the appended claims.

What is claimed is:

1. A dimming circuit connected to an AC line, comprising:
a dimming adjuster circuit connected to the AC line, the dimming adjuster circuit comprising a dimming level adjuster and configured to generate a tracking signal indicative of a setting of the dimming level adjuster, the tracking signal generally tracking line voltage of the AC line,
a dimming control circuit coupled to the dimming adjuster circuit, the dimming control circuit configured to receive the tracking signal and generate a dimming signal, and
a transformer circuit coupled to the dimming control circuit, the transformer circuit configured to receive the dimming signal and provide power to a lighting assembly in response to the dimming signal, the transformer circuit comprising a flyback transformer.

2. The dimming circuit of claim 1, further comprising:
a housing different from a housing of the lighting assembly, the housing containing the dimming adjuster circuit, the dimming control circuit, and the transformer circuit.

3. The dimming circuit of claim 1, wherein the dimming circuit has a power factor greater than 0.8.

4. The dimming circuit of claim 1, wherein the dimming control circuit comprises a switch-mode power supply (SMPS) control.

5. The dimming circuit of claim 1, wherein the transformer circuit comprises a switch coupled to the secondary inductance of the flyback transformer.

6. The dimming circuit of claim 5, wherein the switch comprises a diode.

7. The dimming circuit of claim 5, wherein the switch comprises a synchronized switch.

8. The dimming circuit of claim 1, wherein the transformer circuit comprises a transistor coupled to the primary inductance of the flyback transformer.

9. The dimming circuit of claim 1, wherein the dimming level adjuster comprises a potentiometer.
